(19) United States
(12) Patent Application Publication
(10) Pub. No.: US 2012/0044361 A1
(43) Pub. Date: Feb. 23, 2012

(54) Tap Units Having Reverse Path Burst Mode Detection Circuits and Related Methods of Identifying Reverse Path Noise Sources and Reducing Reverse Path Noise Funneling

(75) Inventor: Robert Ryan Riggsby, Hickory, NC (US)

(73) Assignee: CommScope, Inc. of North Carolina

(21) Appl. No.: 12/859,861

(22) Filed: Aug. 20, 2010

(51) Int. Cl. H01P 5/12; H04N 17/00; H01P 1/10

(52) U.S. Cl. 348/192; 333/100; 333/101; 348/E17.001

(57) ABSTRACT

Radio frequency (“RF”) tap units are provided that include an RF input port, an RF output port that is coupled to the RF input port and a plurality of RF tap ports that are coupled to the RF input port. These tap units further include a burst mode detection circuit that is coupled between the RF input port and at least one of the plurality of RF tap ports.

### FIELD OF THE INVENTION

The present invention is directed to cable television (“CATV”) networks and, more particularly, to tap units that are used in such CATV networks and methods of transmitting reverse path communications through such tap units.

### BACKGROUND

CATV networks refer to communications networks that are used to transmit cable television, Internet telephone and/or broadband Internet signals (and perhaps other information) between one or more service providers and a plurality of subscribers, typically over coaxial and/or fiber optic cables. Most conventional CATV networks comprise hybrid fiber-coaxial networks in which fiber optic cables are primarily used to carry signals from the headend facilities of the service provider to various distribution points, while less expensive coaxial cable may be used, for example, to carry the signals into neighborhoods and from their into individual homes, apartment complexes, hotels, businesses, schools, government facilities and other subscriber premises (i.e., the physical locations of the subscribers).

Typically, the service provider is a CATV service provider that may have exclusive rights to offer cable television services in a particular geographic area. The service provider may broadcast a broad variety of CATV channels to the various subscriber premises over the CATV network. Most CATV service providers also offer other services such as, for example, broadband Internet service and digital telephone service. Thus, in many cases, a subscriber may receive CATV service, a broadband Internet connection, and Voice-over-Internet Protocol (“VoIP”) telephone service all through a single RF connection over the CATV network between the service provider and the subscriber premise.

To provide these services to individual subscriber premises, radio frequency (“RF”) tap units are typically connected in series along communications lines (e.g., a coaxial cable) of the CATV network. These tap units typically have an input port that connects to a first segment of the communications line, an output port that connects to a second segment of the communications line, and one or more RF tap ports. Each tap unit splits the signal that is received at its input port, allowing some of the received signal energy to pass through the tap unit to the output port (and thus the tap unit thereby provides a communications path between the first and second segments of the communications line), while the remainder of the received signal energy is split further and provided to the RF tap ports of the tap unit. Cables, such as, for example, coaxial cables, may run between each RF tap port of a tap unit and a respective subscriber premise. In this manner, each RF tap port acts as a branch off of the communications line that is used to provide a communications path between the service provider and an individual subscriber premise over the CATV network. RF signals are transmitted through each RF tap port between the CATV network and an individual subscriber premise. Typically, a tap unit will include multiple tap ports (e.g., four or eight RF tap ports). Thus, each tap unit may be used to provide a communications path between a plurality of subscriber premises and the CATV network.

Communications between the CATV network and individual subscriber premises may be one-way or two-way communications. The information that is transmitted from the CATV network headend facilities to the individual subscriber premises is typically referred to as the “downstream” and/or as the “forward path” communications. The “downstream” signals may include, for example, broadcast signals with the different tiers of CATV channels that are delivered to all subscriber premises that subscribe to the respective tiers of CATV service, along with point-to-point signals such as movies on demand, digital telephone signals, broadband Internet service and the like. The “upstream” or “reverse path” communications from each subscriber premise to the CATV network headend facilities likewise typically comprises point-to-point communications such as, for example, digital telephone signals, broadband Internet service (the signals transmitted by the subscriber) and ordering commands (i.e., ordering information for movies-on-demand and other services). Both the upstream and downstream communications for each subscriber premise are typically run through a tap unit.

### SUMMARY

Pursuant to embodiments of the present invention, RF tap units are provided that include an RF input port, an RF output port that is coupled to the RF input port, and a plurality of RF tap ports that are coupled to the RF input port. These tap units further include a burst mode detection circuit that is coupled between the RF input port and at least one of the plurality of RF tap ports.

In some embodiments, the burst mode detection circuit includes a burst detector circuit and a switching device that is controlled by an output of the burst detector circuit. In such embodiments, the tap unit may further include a first diplexer and a second diplexer, and the burst detector circuit may be coupled between the first and second diplexers. The switching device may have an output that is coupled to a low frequency port of the second diplexer, and may transfer signals present at its input to its output when in a first state, and may isolate the signals present at the input from the second diplexer when in a second state. In some embodiments, the switching device may be configured when it is in its second state to couple the signals present at its input to a first matched termination and/or to couple the low frequency port of the second diplexer to a second matched termination.

In some embodiments, the burst detector circuit may be configured to control the switching device to be in the first state when the burst detector circuit detects that a signal is being transmitted from at least one of the plurality of RF tap ports to the RF input port. In certain embodiments, the switching device may include a first switching device having an input port that is coupled to the first diplexer, a first output port and a second output port that is coupled to a first matched termination and a second switching device having a first output port that is coupled to the first output port of the first switching device, a second output port that is coupled to a second matched termination and an input port that is coupled to the second diplexer. Each matched termination may comprise a resistor that is terminated to a ground voltage.

In some embodiments, the RF tap unit may further include a first directional coupler having an input that is coupled to a low frequency port of the first diplexer, a first output that is coupled to an input of the burst detector circuit, and a second output that is coupled to an input of the switching device. The RF tap unit may also include a power divider network, and the first and second diplexers may be positioned either between the RF input port and the power divider network or between the power divider network and at least some of the plurality of RF tap ports. Moreover, the RF tap unit may be an addressable tap unit that includes a radio frequency receiver and a switched filter circuit that is controlled in response to data received at the radio frequency receiver.

Pursuant to further embodiments of the present invention, methods of reducing reverse path noise funneling in a communications network are provided in which it is determined that a reverse path communication is being transmitted to a headend facility of the communications network through an RF tap unit of the communications network. A reverse path connection is provided through the tap unit in response to determining that this reverse path communication is being transmitted.

In some embodiments, the reverse path connection is provided by re-connecting a disconnected reverse path connection through the tap unit in response to determining that the reverse path communication is being transmitted. These methods may further include disconnecting the reverse path connection through the tap unit in response to determining that no reverse path communication is being transmitted. In some embodiments of these methods, a plurality of subscriber premises may be connected to the headend facility through the RF tap unit, any one of which may transmit the reverse path communication.

In some embodiments, the RF tap unit may include a burst mode detection circuit that is configured to detect if the reverse path communication is being transmitted to the headend facility through the RF tap unit. This burst mode detection circuit may include a burst detector circuit that is configured to determine if the reverse path communication is being transmitted through the RF tap unit, and a switching device that is controlled by an output of the burst detector circuit to disconnect the reverse path connection through the tap unit in response to determining that no reverse path communication is being transmitted through the RF tap unit. The burst detector circuit may control the switching device to complete the reverse path connection through the RF tap unit in response to determining that the reverse path communication is being transmitted through the RF tap unit, and may further control the switching device to couple the reverse path connection through the RF tap unit to a matched termination in response to determining that no reverse path communication is being transmitted through the RF tap unit.

Pursuant to still further embodiments of the present invention, methods of identifying reverse path noise sources in a CATV network are provided in which the signal quality of a signal transmitted from a subscriber premise through the CATV network is measured. A determination is then made as to which ones of a plurality of tap units were configured to provide reverse path connections during a time period when the measured signal quality of the signal transmitted from the subscriber premise through the CATV network exceeded a threshold.

In some embodiments, the method may further include repeatedly measuring the signal quality of the signal transmitted from the subscriber premise through the CATV network and then determining which ones of a plurality of tap units were configured to provide reverse path connections during the respective time periods when the measured signal quality of the signal transmitted from the subscriber premise through the CATV network exceeded the threshold. In these methods, the reverse path noise sources may be identified as the ones of the plurality of tap units that were configured to provide reverse path connections during all of the respective time periods when the measured signal quality of the signal transmitted from the subscriber premise through the CATV network exceeded the threshold. If addressable tap units are provided, the method may also include sending a control signal to one of the addressable tap units that includes a command for the addressable tap unit to reduce the upstream bandwidth between the CATV network and a first port on the addressable tap unit and then measuring the signal quality of another signal transmitted from the subscriber premise through the CATV network.

Pursuant to yet additional embodiments of the present invention, burst mode detection circuits are provided that include an RF input port, an RF output port, a burst detector circuit that is coupled between the RF input port and the RF tap port, and a switching device that is controlled by an output of the burst detector circuit. These burst mode detection circuits may also include a first diplexer that is coupled between the burst detector circuit and the RF output port and a second diplexer that is coupled between the RF input port and the burst detector circuit. The switching device may transfer signals present at its input to the second diplexer when in a first state and may isolate the signals present at its input from the second diplexer when in a second state.

### BRIEF DESCRIPTION OF THE DRAWINGS

FIG. 1 is a simplified, schematic block diagram of a CATV network.

FIG. 2 is a block diagram of a tap unit according to certain embodiments of the present invention.

FIG. 3 is a block diagram of a burst mode detection circuit according to certain embodiments of the present invention that may be used in the tap unit of FIG. 2.

FIG. 4 is a block diagram of a tap unit according to further embodiments of the present invention.

FIG. 5 is a block diagram of an addressable tap unit according to embodiments of the present invention.

FIG. 6 is a block diagram of an embodiment of filter circuits that may be used in the addressable tap unit of FIG. 5.

FIG. 7 is a block diagram of a stand alone burst mode detection circuit according to embodiments of the present invention.

FIG. 8 is a flow chart illustrating methods of identifying reverse path noise sources according to embodiments of the present invention.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements and/or components, but do not preclude the presence or addition of one or more other features, operations, elements, components and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this disclosure and the relevant art and will not be interpreted in an idealized or overly formal sense unless expressly so defined herein.

As discussed above, CATV networks are bi-directional networks that are used to carry downstream (forward path) communications such as broadcast television signals, broadband Internet and digital telephone service to a plurality of subscriber premises, and upstream (reverse path) communications from a subset of those subscriber premises back to the headend facilities of the CATV network. In a typical CATV network in the United States, the downstream communications are transmitted over the 52-1002 MHz frequency band, while the upstream communications are transmitted over the 5-42 MHz frequency band. Other frequency bands are used in other countries, and it will be appreciated that the tap units according to embodiments of the present invention may be configured to operate over any appropriate downstream and upstream frequency bands.

Unfortunately, unwanted noise signals are often generated in individual subscriber premises, particularly at the lower end of the upstream frequency band. This noise may be generated, for example, by poor grounding, faulty equipment and/or improper installation of equipment and/or premise cabling. This noise funnels back into the CATV network. In many instances, this noise can render portions of the upstream bandwidth essentially unusable (e.g., the 5-12 MHz frequency range), thereby limiting the bandwidth available for upstream communications. As CATV networks migrate to higher levels of data compression such as 64 or 128 QAM and/or implement DOCSIS 3.0 channel bonding signaling technologies in order to increase throughput, the reverse path communications may become more sensitive to unwanted noise signals that are generated in individual subscriber premises.

Pursuant to embodiments of the present invention, systems and methods are provided that may be used to reduce the amount of reverse path noise funneling in a CATV network. In particular, pursuant to embodiments of the present invention, burst mode detection circuits are provided that can be used to detect when signals are being transmitted on the reverse path from a subscriber premise over the CATV network and to selectively connect the reverse path between the subscriber premise and the headend equipment only when such reverse path communications are being transmitted. Since reverse path communications may only be occasionally transmitted from a subscriber premise (e.g., during an Internet session or a VoIP digital telephone conversation), the burst mode detection circuits according to embodiments of the present invention may be used to reduce or eliminate the noise funneling from individual subscriber premises for large blocks of time, thereby reducing the amount of reverse path noise introduced into the network.

Herein the term “burst mode detection circuit” refers to a circuit that is configured to (1) detect the presence of one or more reverse path communications from a subscriber premise or from a group of subscriber premises and to (2) provide a reverse path connection between the subscriber premise(s) and headend facilities of the network when such reverse path communication(s) are present. A “reverse path communication” refers to an information signal that is transmitted from a subscriber premise to headend or other facilities of the communications network. The burst mode detection circuits according to embodiments of the present invention may also be further configured to disconnect the reverse path connection between the subscriber premise(s) and the headend facilities of the network when it is determined that no intentional reverse path communications are present.

As is known to those of skill in the art, signal amplifiers are often provided in subscriber premises to boost the received signal level in either or both the forward and/or reverse paths. Burst mode detection circuits could be implemented in these signal amplifiers as a mechanism for reducing reverse path noise funneling in CATV networks. However, many subscriber premises may not include a signal amplifier, and hence this approach would only work to reduce reverse path noise funneling at the subset of subscriber premises that include signal amplifiers. Moreover, many CATV service providers are implementing upgrades to their networks that are designed to boost signal levels at the subscriber premises, and these upgrades may further reduce the number of subscriber premises having signal amplifiers. Additionally, providing a burst mode detection circuit at each subscriber premise may not be economically feasible in some CATV networks. Thus, while burst mode detection circuits could be implemented in signal amplifiers to reduce reverse path noise funneling, it may not be a realistic option in all CATV networks.

As discussed in detail below, in some embodiments of the present invention, the burst mode detection circuits may be implemented in the tap units that provide taps from a communications line in the network to individual subscriber premises. As essentially all subscriber premises connect to the network through such tap units, this approach allows a network operator to use the burst mode detection circuits to reduce reverse path noise funneling from essentially all of the subscriber premises in the network, if so desired. Moreover, as tap units typically include 2, 4 or 8 tap ports (although other numbers of tap ports are possible), the total number of burst mode detection circuits that are provided may be reduced in some embodiments to decrease the overall cost of this network upgrade.

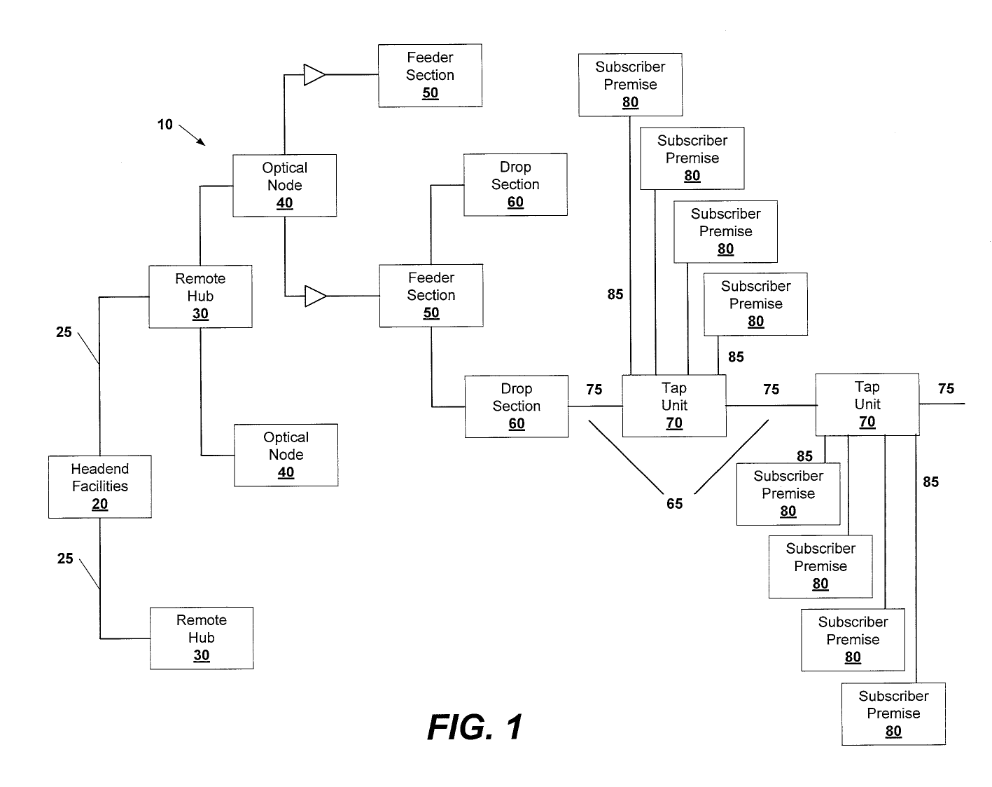

FIG. 1 is a simplified, schematic block diagram of a CATV network. As shown in FIG. 1, the CATV network 10 includes headend facilities 20 where signals (e.g., broadcast and other signals) from various sources, such as transmissions from satellites, microwave, fiber optic and other sources, are gathered and processed for transmission over the CATV network 10. These signals are distributed via a main or “trunk” network 25 to a plurality of remote hubs 30. The signals may be further distributed from each remote hub 30 to a plurality of optical nodes 40, where the signals are typically amplified. Each optical node 40 may feed a plurality of feeder sections 50. Each feeder section 50 may feed a plurality of drop sections 60. The communications lines 65 running from each drop section 60 are routed through neighborhoods and the like. A plurality of tap units 70 are typically provided on each cable 65. The tap units 70 divide the communications lines 65 into a plurality of segments 75, which are typically implemented as hardline cable segments 75. The hardline cable segments 75 are used to connect adjacent tap units 70 in series. Each tap unit 70 has one or more tap ports. Coaxial cable segments 85 are used to connect each tap port to one of a plurality of individual subscriber premises 80. Thus, the tap units 70 provide each subscriber premise access to the CATV network 10. The individual subscriber premises 80 may comprise, for example, single dwelling homes, multiple dwelling units such as apartment buildings, condominiums, hotels and the like, businesses, schools, government facilities etc. Typically, the tap units 70 are located outside, perhaps within an enclosure, near the subscriber premises 80 (i.e., on the outside of a building, in a cable box near the street, etc.). Note that in FIG. 1 only two remote hubs 30, optical nodes 40, feeder sections 50 and drop sections 60 are pictured to simplify the drawing, and downstream components are depicted off only one of these two stations or sections for the same reason.

It will be appreciated that the CATV network depicted in FIG. 1 is greatly simplified. It will likewise be appreciated that the methods and systems according to embodiments of the present invention discussed below may be used with a wide variety of different CATV networks. Thus, it will be appreciated that the cable network depicted in FIG. 1 and the systems and components depicted in the other figures of the present application are exemplary in nature, and are not intended to be limiting as to the scope of the present invention as defined in the claims appended hereto.

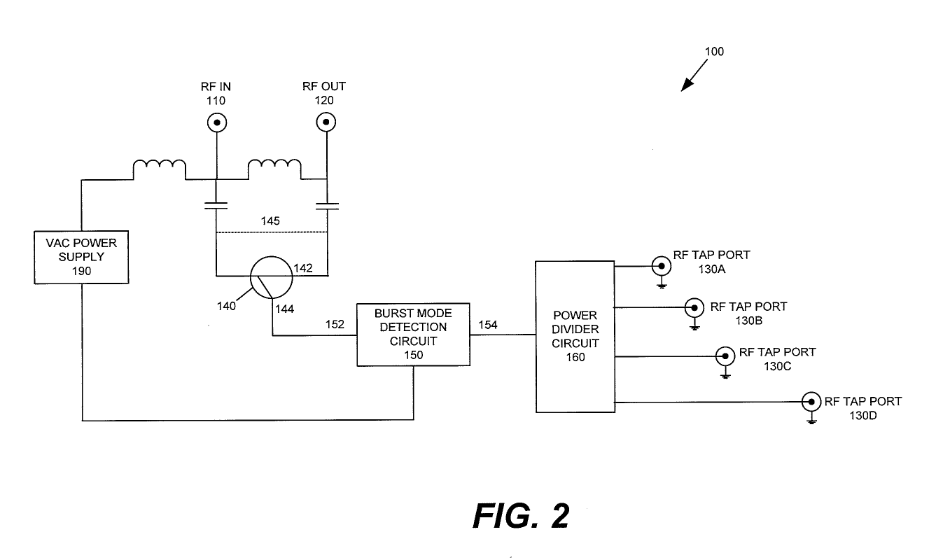

According to embodiments of the present invention, tap units are provided that include burst mode detection circuits. These tap units may be used to reduce reverse path noise funneling from individual subscriber premises into a CATV network. FIG. 2 is a block diagram of a tap unit 100 that includes a burst mode detection circuit according to certain embodiments of the present invention. Each of the tap units 70 in CATV network 10 of FIG. 1 could be implemented as one of these tap units 100.

As shown in FIGS. 1 and 2, the tap unit 100 includes an RF input port 110, an RF output port 120, and a plurality of RF tap ports 130A-130D. The RF input port 110 may receive a hardline cable segment that connects the tap unit 100 to a drop section 60 (such as the leftmost hardline cable segment 75 in FIG. 1), or a hardline cable segment that connects the tap unit 100 to another tap unit 100 (such as the rightmost or middle hardline cable segments 75 in FIG. 1). The RF output port 120 typically receives a hardline cable segment 75 that connects the tap unit 100 to another tap unit 100. The RF input port 110 and RF output port 120 facilitate connecting the tap unit 100 in series along the communications line 65 that extends from the drop section 60 (see FIG. 1) so that a plurality of tap units 100 may be connected to the same drop section 60 along the communications line 65 that comprises a plurality of cable segments 75.

As further shown in FIG. 2, the tap unit 100 includes a directional coupler 140 and a burst mode detection circuit 150. The directional coupler 140 has a first output port 142 and a second output port 144. The directional coupler 140 splits the RF signal that is received at the RF input port 110. Typically, the directional coupler 140 will be configured to pass most of the signal energy input at RF input port 110 through the first output port 142 to the RF output port 120, while the remaining signal energy is passed through the second output port 144 to the burst mode detection circuit 150. Thus, the directional coupler 140 is used to split off a small portion of the signal energy received at the RF input port 110 that will be fed to the subscriber premises 80 that are connected to the CATV network 10 through the tap unit 100. The remaining signal energy that passes to the RF output port 120 may be passed along hardline cable segment(s) 75 to one or more additional downstream tap units 100 (see FIG. 1). The directional coupler 140 also acts to combine reverse path communications from the subscriber premises 80 that are connected to the CATV network 10 through the tap unit 100 with other reverse path communications that are carried on communications line 65 for transmission to the headend facilities of the CATV network 10. Note that herein the term “directional coupler” is used to refer to couplers that split/combine received signal energy either equally or unequally. Directional couplers that equally split/combine received signal energy may also be referred to herein as “splitters.”

In some embodiments, the directional coupler 140 may comprise a “plug-in” directional coupler 140. By “plug-in” it is meant that the directional coupler 140 is configured to be field-installable and/or field-removable by inserting the directional coupler 140 into a mating slot, recess, housing and/or other receptacle. Such “plug-in” directional couplers 140 further include electrical contacts (not shown) that mate with corresponding electrical contacts in the mating slot, recess, housing and/or other receptacle. As such, a technician may readily install and/or replace these plug-in directional couplers 140 in the field simply by pulling out any directional coupler that is to be replaced and plugging a new directional coupler 140 into the mating slot, recess, housing and/or other receptacle. One or more retainment mechanisms such as snap latches, clips, screws or the like may be included that ensure that the directional coupler 140 remains firmly in place after it is plugged in. Such retainment mechanisms may need to be disengaged or removed in order to remove one directional coupler 140 and replace it with another plug-in directional coupler 140. It will also be appreciated that in some embodiments of the present invention the directional coupler 140 is not a plug-in directional coupler 140.

As known to those of skill in the art, the amount of energy that the directional coupler 140 ideally passes into the tap unit 100 depends upon a variety of factors, such as the distance of the tap unit from the last amplifier in the CATV network 10, the distance of the tap unit 100 from the subscriber premises 80 that the tap unit 100 serves, the number of tap ports on the tap unit 100, etc. By configuring the tap unit 100 to have a plug-in directional coupler an installer or operator may choose the appropriate directional coupler (i.e., one that directs an appropriate amount of signal energy into the tap unit 100) for the tap unit at the time that the tap unit 100 is installed and plug it into the socket in the tap unit 100. With this plug-in directional coupler capability, a CATV operator can stockpile the directional couplers having the appropriate values, but may only need to stockpile a small number of different tap units.

As further shown in FIG. 2, the tap unit 100 may also include a non-interruptible contact 145 for the plug-in directional coupler 140. This non-interruptible contact 145 maintains a radio frequency path from RF input port 110 to RF output port 120 even if the plug-in directional coupler 140 is not installed or is temporarily removed, for example, during maintenance operations. Thus, the non-interruptible contact 145 allows the tap unit 100 to pass signals between the headend facilities and downstream tap units 100 (and their associated subscriber premises 80) even when the plug-in directional coupler 140 is not installed in the tap unit 100. Insertion of a plug-in directional coupler 140 disables the non-interruptible contact 145. The contact 145 is referred to as a “non-interruptible” contact because it is configured so that a significant (or, in some cases, even a noticeable) break in service will not occur for downstream tap units 100 when the plug-in directional coupler 140 is plugged into, or removed from, the tap unit 100.

As shown in FIG. 2, the non-interruptible contact 145 provides an alternate signal carrying path that bypasses the plug-in directional coupler 140. In some embodiments of the present invention, the non-interruptible contact 145 may be implemented as a signal carrying path that is mechanically open-circuited when a directional coupler 140 is plugged into the tap unit 100. For example, in one specific embodiment, the non-interruptible contact 145 may be implemented as a metal contact beam that is shaped to have good contact force and elastic “memory.” When the non-interruptible metal contact beam 145 is “engaged” (which occurs when the plug-in directional coupler 140 is not installed in the tap unit 100), the non-interruptible metal contact beam 145 makes mechanical and electrical contact between a radio frequency input point and a radio frequency output point to provide an alternate radio frequency path. In contrast, when plug-in directional coupler 140 is installed in the tap unit 100, the plug-in directional coupler 140 mechanically moves the non-interruptible metal contact beam 145, thereby open-circuiting the alternate radio frequency path. The non-interruptible metal contact beam 145 may be designed so that upon removal of the plug-in directional coupler 140 the non-interruptible metal contact beam 145 immediately re-establishes the alternate radio frequency path to ensure that no significant and/or noticeable break occurs in downstream service.

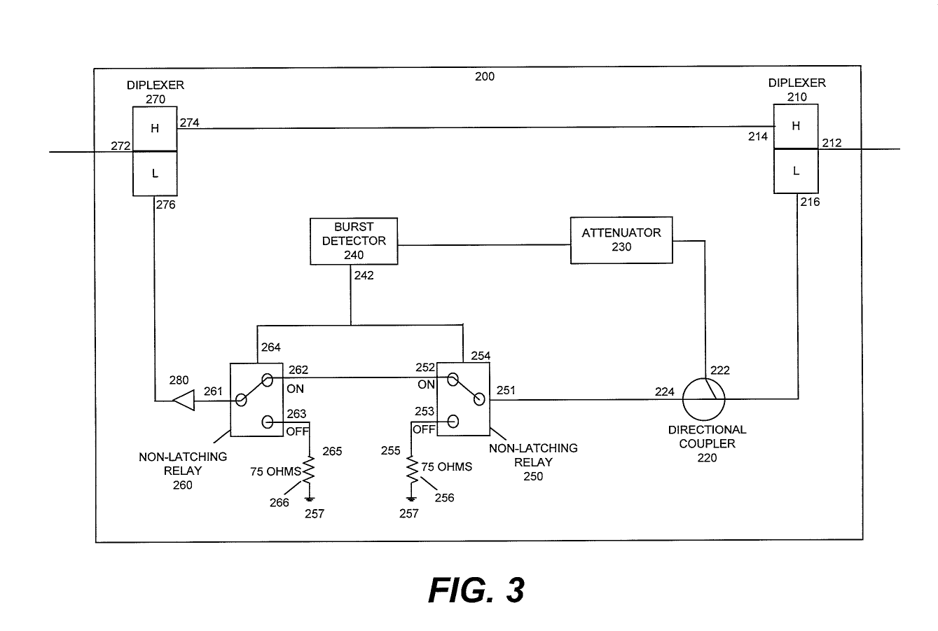

As further shown in FIG. 2, the tap unit 100 includes a burst mode detection circuit 150. A first input/output port 152 of the burst mode detection circuit 150 is coupled to the second output port 144 of the directional coupler 140. As noted above, the burst mode detection circuit 150 may comprise a circuit that is configured to (1) detect the presence of one or more reverse path communications from a subscriber premise or from a group of subscriber premises and to (2) provide a reverse path connection between the subscriber premise(s) and headend facilities of the network when such reverse path communication(s) are present. An exemplary burst mode detection circuit will be discussed in detail below with reference to FIG. 3. The burst mode detection circuit 150 may detect the presence of one or more reverse path communications from the subscriber premises by, for example, examining the spectra of the reverse path over time to detect “bursts” of signal energy that are separated by an amount of time that corresponds to a frame structure of a time division multiple access scheme used to transmit the reverse path communications. When such bursts of energy are identified in the reverse path spectra (e.g., within the 5-42 MHz frequency band), the burst mode detection circuit 150 may determine that communications are present on the reverse path. While the above describes one exemplary method by which a burst mode detection circuit 150 can operate to detect the presence of reverse path communications, it will be appreciated that other methods detecting the presence of reverse path communications may also be used.

As is further shown in FIG. 2, the second input/output port 154 of the burst mode detection circuit 150 is connected to an input of a power divider network 160. The power divider network 160 may comprise, for example, a layered network of directional couplers that further divide the received RF input signal into a desired number of signals. The power divider network 160 divides the forward path RF signal so that a portion of this forward path signal is received at each of the outputs of the power divider network 160. Likewise, with respect to reverse path communications, the power divider network 160 combines these RF signals into a composite RF signal. Typically, the directional couplers used in the power divider network 160 comprise splitters. While a 1×4 power divider network 160 is depicted in FIG. 2, it will be appreciated that the power divider network 160 may have any number of outputs (e.g., 1×2, 1×4 and 1×8 power divider networks 160 may be used).

Each output of the power divider network 160 is connected to one of the plurality of bi-directional RF tap ports 130A-D. Respective coaxial cables 85 connect each bi-directional RF tap port 130A-D to a respective subscriber premise 80 (see FIG. 1). The bi-directional RF tap ports 130A-D are be used to pass RF signals from the tap unit 100 to one or more end devices that are located, for example, in the subscriber premise 80, and to pass signals from such end devices to the tap unit 100. Any appropriate end device that may send and/or receive an RF signal may be placed in communication with the bi-directional tap ports 130A-D. For example, end devices such as Internet telephones, cable television sets, cable modems and/or other data communication devices may be connected to the tap unit 100 via the RF tap ports 130A-D. In some cases, an RF signal amplifier, power divider network and/or other devices (not shown in FIG. 2) may be placed between the RF tap port 130A-D and these end devices.

The tap unit 100 may further include a VAC power supply 190. The power supply 190 may receive an alternating current power signal that is transmitted over the CATV network 10 to, for example, power amplifiers and other equipment in network 10. The power supply 190 may generate and output a direct current voltage VCC (e.g., a 5 volt signal) that is used to power various components in the tap unit 100 such as, for example, various components of the burst mode detection circuit 150.

While FIG. 2 illustrates one exemplary tap unit 100 that includes a burst mode detection circuit 150, it will be appreciated that burst mode detection circuits 150 may be included in a wide variety of conventional or non-conventional tap unit designs.

FIG. 3 is a block diagram of a burst mode detection circuit 200 according to certain embodiments of the present invention. The burst mode detection circuit 200 may be used, for example, to implement the burst mode detection circuit 150 of the tap unit of FIG. 2.

As shown in FIG. 3, the burst mode detection circuit 200 includes a first high-low diplexer 210, a directional coupler 220, an attenuator 230, a burst detector circuit 240, first and second switching devices 250, 260, a second high low diplexer 270, and an amplifier 280. The first high-low diplexer 210 is used to separate the high frequency forward path signal from any low frequency reverse path signals. The diplexer 210 has a common port 212, a high frequency port 214 and a low frequency port 216. In some embodiments, the diplexer 210 can be configured to filter the signals in a manner such that signals with frequencies greater than approximately 45-50 MHz are passed from the high frequency port 214 to the common port 212, and to pass low frequency signals in the reverse path from the common port 212 to the low frequency port 216.

The low frequency signals that pass in the reverse path to the low frequency port 216 may be passed to the passive directional coupler 220. The directional coupler 220 splits off a small part of the received low frequency signal energy and passes it through a first output port 222 to an attenuator 230. The attenuator 230 feeds the signal energy to the burst mode detector 240, and may be used to reduce the signal level of these signals (if necessary). In some embodiments, the attenuator 230 may be omitted or may be located in a different position (e.g., at the input to the directional coupler 220). The remaining signal energy received at the input of the directional coupler 220 passes through the second output port 224 of directional coupler 220 to the first switching device 250.

The burst detector circuit 240 receives the split-off version of the reverse path signal that is passed through the output of the attenuator 230. As noted above, in most CATV networks, the signals in the reverse path comprise Time Division Multiple Access (“TDMA”) signals in which multiple users share a frequency band by communicating only during a certain time slice of a communications frame. As a result, the reverse path signals have a “bursty” nature in that the signals appear as a spike of signal energy at a certain frequency at spaced-apart time increments that correspond to a users time slot in each of a series of communications frames. In some embodiments of the present invention the burst detector circuit 240 may comprise a circuit that analyzes the spectrum of the signal on the reverse path to identify when “bursts” of signal energy appear in a manner that suggests that reverse path signals are being transmitted by one or more of the subscriber premises 80 that are connected to the CATV network 10 via the tap unit 100.

The output of the burst detector circuit 240 may be a control signal that is output on port 242 of the burst detector circuit 240. When the burst mode detector 240 detects that one or more signals are being transmitted on the reverse path, the control signal output at port 242 may take on a first value (e.g., logic 1), and will otherwise will have a second value (e.g., logic 0). The control signal output at port 242 is provided to the switching devices 250, 260. It will be appreciated that other control signal schemes may be used without departing from the scope of the present invention.

The second output 224 of directional coupler 220 is fed to the switching devices 250, 260. These switching devices 250, 260 may be implemented, for example, as two discrete switching devices as shown in FIG. 3. In another exemplary embodiment, the switching devices 250, 260 may be implemented as a single integrated switching device. Other designs are also possible. In some embodiments, the switching devices may comprise switches/relays (the terms “switch” and “relay” are used interchangeably herein) such as an SPDT non-latching relay. As shown in FIG. 3, in the depicted embodiment, the first switching device 250 includes an “input” port 251, first and second “output” ports 252, 253, and a control port 254. The switching device 250 is set to connect input port 251 to one of the first and second output ports 252, 253, with the control signal that is input to port 254 controlling which of the output ports 252, 253 is connected to the input port 251. In particular, when the control signal input to port 254 has the first logic value (indicating that reverse path signals are present), the switching device 250 is set in its “ON” position to connect input port 251 to output port 252, thereby allowing the reverse path communications to flow through the switching device 250. In contrast, when the control signal input to port 254 has the second logic value (indicating that no reverse path signals are present), the switching device 250 is set in its “OFF” position to connect input port 251 to output port 253 thereby breaking the communications path such that energy on the reverse path does not flow through the switch 250. This effectively disconnects the subscriber premises 80 that are connected to tap unit 100 from the CATV network 10.

The output port 252 of the first switching device 250 is connected to a first output port 262 of the second switching device 260. The second switching device 260 further includes a first input port 261, a second output port 263 and a control port 264. The switching device 260 is configured so that when the control signal input to port 264 has the first logic value (indicating that reverse path signals are present), the switching device 260 is set in its “ON” position to connect input port 261 to output port 262, thereby allowing the reverse path communications to flow through the second switching device 260. In contrast, when the control signal input to port 264 has the second logic value (indicating that no reverse path signals are present), the second switching device 260 is set in its “OFF” position to connect input port 261 to output port 263.

It will be appreciated that, in some embodiments, the control signal output on port 242 of the burst detector circuit 240 may not immediately trigger the switching devices 250, 260 to switch from their “ON” positions to their “OFF” positions when an absence of reverse path communications is detected. Instead, the switching devices 250, 260 may be controlled, for example, to remain in their “ON” positions for some predetermined period of time (which may be variable) in the anticipation of future reverse path communications, but then switch to their “OFF” positions if no such additional reverse path communications are received within a given time period.

As shown in FIG. 3, output port 253 of switching device 250 and output port 263 of switching device 260 are each coupled to matched terminations 255, 265, which in this particular embodiment are implemented as 75 ohm resistors 256, 266 that are connected in series to a ground voltage 257. As such, when the switching device 250 is in its “OFF” position, the second output port 224 of directional coupler 220 is connected to matched resistive termination 255. Reflections and interference from the tap unit 100 into the subscriber premises 80 which may degrade the downstream communications can be reduced by including the matched termination 255 on switching device 250. Similarly, as the second output port 263 of switching device 260 is connected to matched resistive termination 265 when the switching device 260 is in its “OFF” position, the CATV network likewise terminates through the low frequency input of the high-low diplexer 270 to a matched termination. As such, reflections and interference from the tap unit 100 into CATV network 10 can similarly be reduced by including the matched termination 265 on switching device 260.

Herein, the term “matched termination” is used to refer to a termination that approximately matches the specific transmission path's impedance (in this case 75 ohms), thus being capable of substantially absorbing the possible propagation modes with relatively minimal reflection. The term “resistive termination” is used to refer to a termination that includes at least one purposefully resistive element such as a resistor. By providing such a matched resistive terminations 255, 265, both the subscriber premises 80 and the CATV network 10 may be properly terminated when the switching devices 250, 260 are in their OFF positions so as to disconnect the reverse path from the CATV network 10, and hence reflections that result in return loss, frequency response and/or other signal degradation can be reduced in these circumstances. Additionally, as the reverse path is disconnected, noise funneling from the subscriber premises 80 into the CATV network 10 may be reduced or eliminated during periods when no reverse path communications are being transmitted, which may improve the overall performance of the CATV network 10.

As is also shown in FIG. 3, the input 261 of switching device 260 is connected to diplexer 270. The diplexer 270 has a common port 272, a high frequency port 274 and a low frequency port 276. The input 261 of switching device 260 is connected to the low frequency port 276 of diplexer 270. The diplexer 270 outputs the reverse path signals received from the switching device 260 to the CATV network, while preventing the low frequency signals from funneling into the forward path from the CATV network 10 to the subscriber premises 80.

The burst mode detection circuit 200 may also, in some embodiments, include an amplifier 280, which may be located in a variety of different locations along the reverse path. In the particular embodiment of FIG. 3, the amplifier 280 is located between the input 261 of the second switching device 260 and the low frequency port 276 to the high-low diplexer 270. In various embodiments, the power amplifier 280 can optionally be omitted.

It will also be understood that various of the components of FIG. 3 may be omitted or replaced with other components, and that the location of the various components may also be modified. For example, in some embodiments, the attenuator 230 may be located between the diplexer 210 and the directional coupler 220. In other embodiments, the attenuator 230 may be omitted altogether. Likewise, the power amplifier 280 could be located elsewhere along the reverse path and/or could be omitted. Various other modifications are also possible without departing from the scope of the present invention.

In the particular embodiment depicted in FIGS. 2 and 3, the switching devices 250, 260 are non-latching relays that require a DC power source. The burst detector circuit 240 may also require a DC power source, as does the amplifier 280 (if included in the burst mode detection circuit 200). As shown in FIG. 2, AC power may be input to the tap unit 100 at the RF input port 110, and provided to a VAC power supply 190. This power supply 190 outputs a DC voltage VCC that may be used to power the switching devices 250, 260, the burst detector circuit 240 and the power amplifier 280 of FIG. 3. It will be appreciated that in other embodiments, the switching devices may not require a separate power source.

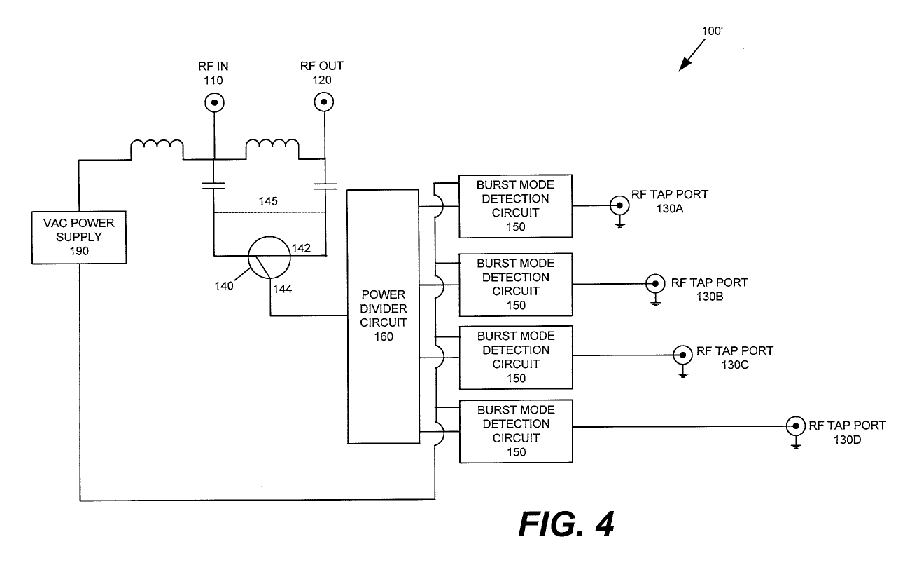

FIG. 4 is a block diagram of a tap unit 100′ according to further embodiments of the present invention. As shown in FIG. 4, the tap unit 100′ may include the exact same components as the tap unit 100. Accordingly, like components have been labeled using the same reference numerals as in FIG. 2 and operation of these components will not be further described here. The difference between the embodiments of FIGS. 2 and 4 is that in the embodiment of FIG. 2, a single burst mode detection circuit 150 is included between the plug-in directional coupler 140 and the power divider network 160, while in the embodiment of FIG. 4, four such burst mode detection circuits 150 are provided between the power divider network 160 and the respective RF tap ports 130A-H. Each of these four burst mode detection circuits 150 may have, for example, the design of circuit 200 of FIG. 3. By providing four burst mode detection circuits 150, the reverse path may be disconnected for each subscriber premise 80 during periods of time when no reverse path communications are being transmitted from that particular subscriber premise 80, and hence the tap unit 100′ of FIG. 4 may further reduce reverse path noise funneling as compared to tap unit 100 (as tap unit 100 only disconnects the reverse paths from the four subscriber premises 80 during time periods when none of the subscriber premises 80 are transmitting reverse path communications).

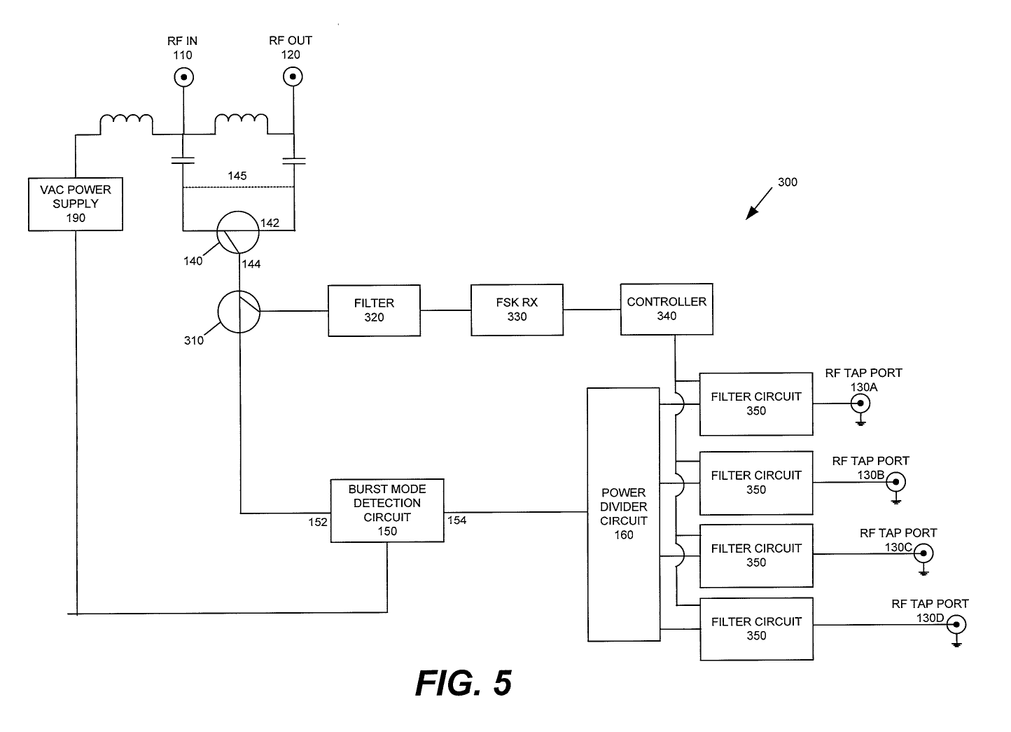

FIG. 5 is a block diagram of an addressable tap unit 300 that includes a burst mode detection circuit according to embodiments of the present invention. Each of the tap units 70 in the CATV network 10 of FIG. 1 could be implemented as one of these tap units 300. The tap unit 300 includes each of the components that are included in the tap unit 100 of FIG. 2. These like components are labeled with the same reference numerals used in FIG. 2, and, for the sake of brevity, the operation of these components will not be discussed further here. In addition, the tap unit 300 includes a number of additional components that allow the tap unit 300 to operate as an “addressable” tap unit.

The tap unit 300 comprises an “addressable” tap unit in that each of the RF tap ports 130A-130D of tap unit 300 may be turned on or off or otherwise configured from a remote location. A cable television service provider may use these addressable taps to control, from a remote location, which signals are passed in the downstream and/or the upstream direction between the cable service provider and specific subscriber premises. Consequently, a cable service provider may use the addressable tap units to add, drop and/or change the services provided to a particular subscriber premise without the need to send a service technician to the subscriber site.

The tap unit 300 differs from the tap unit 100 in that it includes a second directional coupler 310 that is coupled to the second output 144 of directional coupler 140. Most of the signal energy received by directional coupler 310 passes to the burst mode detection circuit 150, but a small amount of the signal energy is split off and passed to a filter 320. The filter 320 is used to pass a frequency band on which control signals are embedded in the downstream signal transmitted from the CATV network 10, while filtering out the remainder of the downstream and upstream signals. The output of the filter 320 is coupled to a receiver 330. In this particular embodiment, the receiver 330 comprises a radio frequency FSK receiver having demodulation capabilities. Command signals received from the cable television network 10 are coupled to the FSK receiver 330 where they are received and demodulated. The demodulated commands are output by the FSK receiver 330 to a controller 340 which may be implemented, for example, as a microprocessor, microcontroller, logic circuit or the like. The controller 340 outputs one or more control signals that are used to control the setting of a plurality of filter circuits 350. A filter circuit 350 is provided between the outputs of the power divider network 160 and the RF tap ports 130A-D. The filter circuits 350 may comprise “plug-in” filter circuits, and a non-interruptible contact (not shown) may be provided for each plug-in filter circuit 350 to maintain communications even if the plug-in filter circuit 350 is not installed or is temporarily removed.

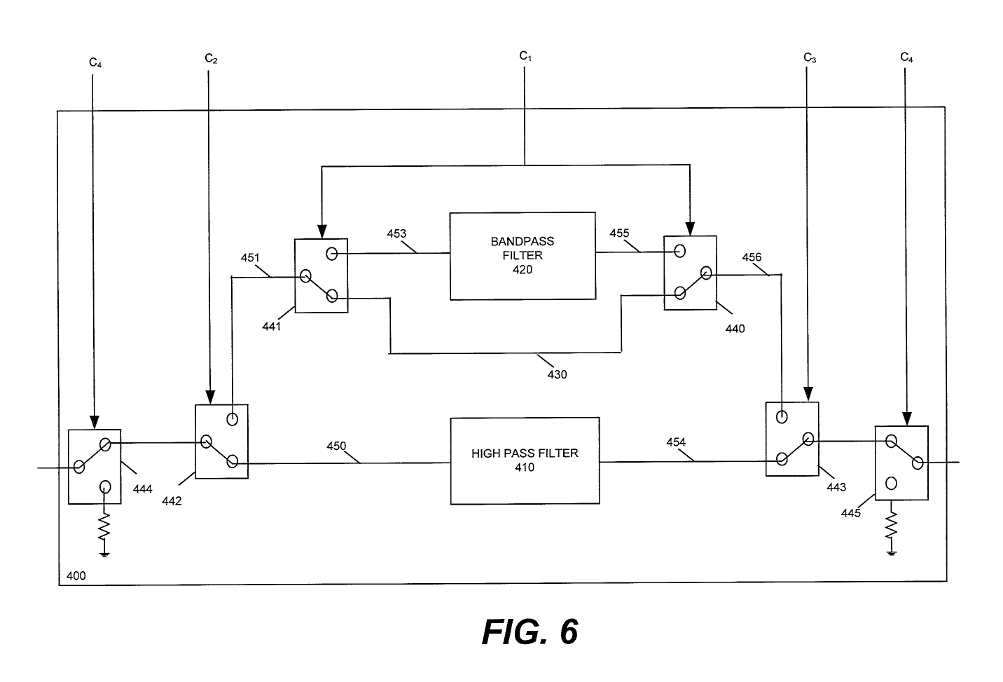

FIG. 6 is a block diagram of one implementation of a filter circuit 400 that may be used to implement the filter circuits 350 of FIG. 5. As shown in FIG. 6, the filter circuit 400 may include a high pass filter 410, a bandpass filter 420, a filter free signal carrying path 430 and switches 440-445. The high pass filter 410 may comprise, for example, a filter that passes signals having a frequency above, for example, 50 MHz while attenuating lower frequency signals. The bandpass filter 420 may comprise, for example, a filter that passes signals in one or more selected frequency ranges within, for example, the 5-1000 MHz frequency band while attenuating signals in other frequency ranges. By way of example, the bandpass filter 420 may be configured to pass signals in frequency bands that provide a subscriber with 911 digital telephone service and standard cable television service, while attenuating/blocking signals in all other frequency ranges and thus disabling other services such as normal digital telephone service, premium cable television service and pay-per-view and movies-on-demand services.

The switches 440-445 comprise two-position switches that are configured to open one of two possible signal paths and close the other signal path in response to a control signal that is applied to the switch. The switches 440-445 are controlled by control signals C1-C4 which are generated by the controller 340 of FIG. 5 (hence for a four port tap unit, the controller 340 generates a total of 12 control signals that independently control the three switches on each of the four filter circuits 350). As shown in FIG. 6, control signal C1 controls switches 440 and 441, control signal C2 controls switch 442, control signal C3 controls switch 443, and control signal C4 controls switches 444 and 445.

In this particular embodiment, each filter circuit 400 may be set to one of four different modes by appropriate selection of the control signals C1-C4 in order to control the signals that pass through the tap associated with each filter circuit 400. In an exemplary embodiment, these four different modes may be as follows:
1. “ON” mode—Passes the full downstream frequency band (e.g., 51-1000 MHz) from the cable service provider to the subscriber premise, and passes the full upstream frequency band (e.g., 5-40 MHz) from the subscriber premise to the cable service provider.
2. “OFF” mode—Does not pass any signals between the cable service provider and the subscriber premise in either the upstream or the downstream frequency bands.
3. “HIGH PASS” mode—Passes the full downstream frequency band from the cable service provider to the subscriber premise, while blocking the full upstream frequency band from the subscriber premise to the cable service provider.
4. “WINDOW” mode—Passes selected portions of the downstream frequency band from the cable service provider to the subscriber, and passes selected portions of the upstream frequency band from the subscriber to the cable service provider. The WINDOW mode may be used to pass frequencies associated with one or more specific tier(s) of services which an individual subscriber has ordered.

The filter circuit 400 may be set to the ON mode by setting control signal C2 so that switch 442 connects to path 451, setting control signal C1 so that switches 440 and 441 connect to the filter free signal carrying path 430, setting control signal C3 so that switch 443 connects to path 456, and setting control signal C4 so that switch 444 connects to switch 442 and switch 445 connects to switch 443. In this manner, signals incident at the input of either switch 444 or switch 445 flow through the filter free signal carrying path 430, and hence all signals in the downstream and upstream frequency bands may be passed between the subscriber premise and the cable television service provider. Similarly, to set the filter circuit 400 to the OFF mode, control signal C4 is set so that switches 444 and 445 are connected to their grounded terminations. In this manner, signals incident at the input of either switch 444 or switch 445 are connected to ground and are not passed. In order to set the filter circuit 400 to the HIGH PASS mode (i.e., the signals are routed through the high pass filter 410), control signal C2 is set so that switch 442 connects to path 450, control signal C3 is set so that switch 443 connects to path 454, and control signal C4 is set so that switch 444 connects to switch 442 and switch 445 connects to switch 443. Finally, in order to set the filter circuit 400 to the WINDOW mode (i.e., the signals are routed through the bandpass filter 420), control signal C2 is set so that switch 442 connects to path 451, control signal C1 is set so that switch 441 connects to path 453 and switch 440 connects to path 455, control signal C3 is set so that switch 443 connects to path 456, and control signal C4 I sset so that switch 444 connects to switch 442 and switch 445 connects to switch 443. Other switch settings may also be used to implement the various modes.

It will also be appreciated that the addressable tap unit of FIG. 5 may be modified to have burst mode detection circuits 150 included on each addressable tap in the same manner that the non-addressable tap unit 100 of FIG. 2 was modified to provide the addressable tap unit 100′ of FIG. 4. In such an embodiment, the burst mode detection circuits 150 could be placed between the respective outputs of the power divider network 160 and the filter circuits 350, or could be placed between the filter circuits 350 and their respective tap ports 130A-D.

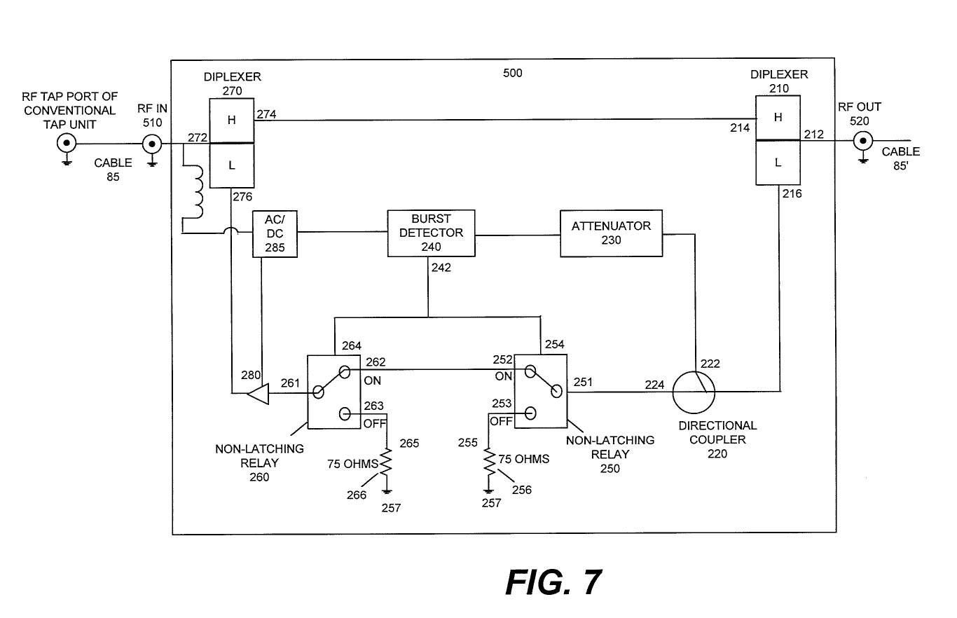

According to further embodiments of the present invention, the burst mode detection circuit 150 of tap unit 100 may be implemented as a stand-alone unit. For example, in the embodiment of FIG. 4, each of the four burst mode detection circuits 150 could be implemented as a stand-alone burst mode detection circuit that is connected in series on the coaxial cable segments 85 that connect each tap port 130A-D to a respective subscriber premises 80. FIG. 7 is a block diagram illustrating a stand-alone burst mode detection circuit 500 that illustrates how the stand-alone circuit may be placed in series on the cable connection between a tap port of a tap unit and a subscriber premises 80.

As shown in FIG. 7, the circuitry included in the burst mode detection circuit 500 may be identical to circuitry included in the burst mode detection circuit 200 of FIG. 3. The primary difference between these circuits is that the burst mode detection circuit 500 may include a weatherproof housing (not shown) and may include an RF input port 510 that may receive the coaxial cable segment 85 that is connected to an RF tap port of a conventional tap unit (not shown in FIG. 7) and an RF output port 520 that receives a coaxial cable segment 85′ that connects the stand-alone burst mode detection circuit 500 to a subscriber premise 80 (not shown in FIG. 7). Additionally, the burst mode detection circuit 500 further includes a power provision circuit. In the depicted embodiment, the power provision circuit comprises an AC/DC power supply 285 that converts AC power that is provided from the headend facilities over coaxial cable 85 into DC power that is used to power, for example, amplifier 280 and/or burst detector 242. However, it will also be appreciated that the burst mode detection circuit 500 may be powered in other ways. For example, in other embodiments, a DC/DC power supply (not shown) may be used to power the, amplifier 280 and/or burst detector 242 using power supplied through RF output port 520. The stand-alone burst mode detection circuit 500 may be used to upgrade an existing conventional tap unit to have the functionality provided by the tap units according to embodiments of the present invention.

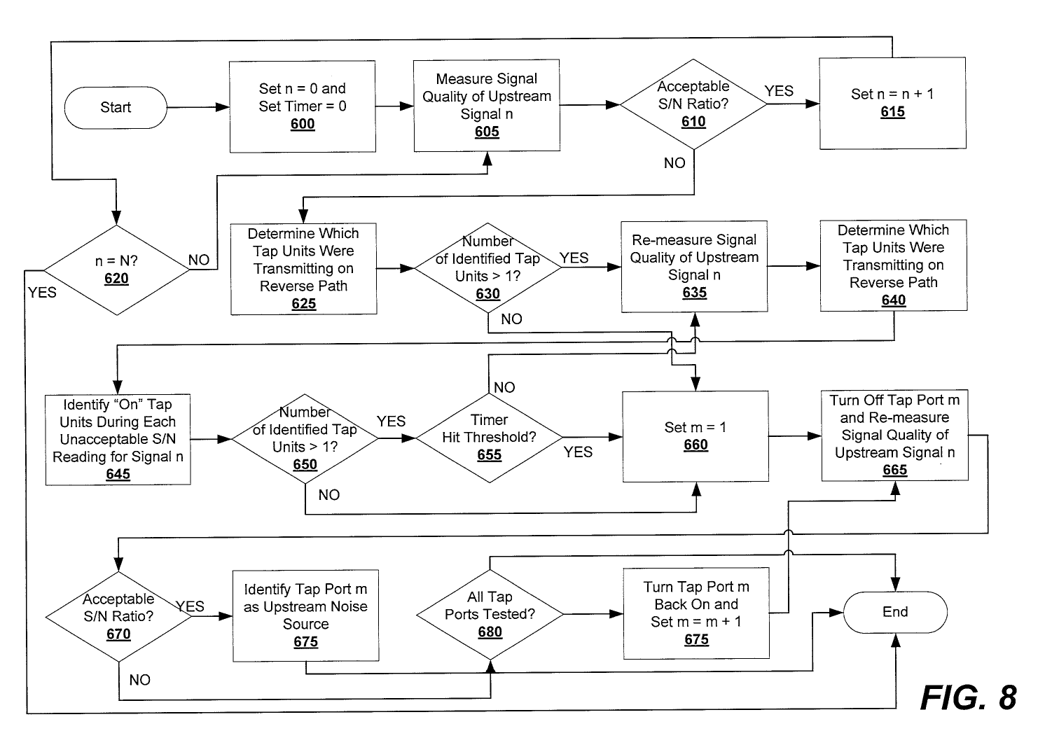

FIG. 8 is a flow chart illustrating methods of identifying the sources of “upstream” noise that is introduced into the cable television network (e.g., noise that is introduced at subscriber premises 80). When noise is detected on conventional CATV networks, a manual effort may be undertaken to determine the node where the noise is entering the network. For example, a service technician may be sent out who physically probes each tap for noise signals. A network management handheld device may be used to track how the noise level in the CATV network varies as each tap is probed in order to identify taps that are introducing significant noise into the network. This process may be expensive and time consuming, and may also degrade or interrupt service to selected customers.

The advent of addressable taps allows much of this manual process to be automated. In particular, an operator (or an automated program) may use the addressable tap units, from a remote location, to turn each addressable tap on and off (typically in the upstream direction only) while measuring the noise present on the network both before and after the addressable taps are turned off. In this manner, a cable service provider may more quickly and efficiently track the noise contribution of individual subscribers, isolate the taps which appear to be the major contributors to the noise introduced onto the network, and/or determine the frequency bands that are the primary contributors to noise inserted into the network from a particular subscriber location. Methods of using an addressable tap unit to identify upstream noise sources in this manner are disclosed, for example, in U.S. patent application Ser. No. 11/943,244, filed Nov. 20, 2007, the entire contents of which are incorporated herein by reference.

The tap units according to embodiments of the present invention may be used to even further streamline the process for identifying reverse path noise sources. In a typical CATV network, the network already tracks the performance of each cable modem that transmits on the reverse path (and is able to specifically identify each such cable modem, and associate that cable modem with the specific tap unit that provides it access to the network). Since most tap units in the network are not transmitting at any given time, when a noise spike occurs, the network will know that the noise is likely being introduced from one of the subscriber premises that has a reverse path connected to the network at the time the noise spike occurred. Since the addressable tap units according to embodiments of the present invention that have their reverse path connected to the network will change over time (as different subscriber premises send or stop sending reverse path communications), the performance data can be analyzed to quickly identify the tap unit or units that are introducing significant noise into the network.

One such method of identifying reverse path noise sources is depicted in the flow chart of FIG. 8. As shown in FIG. 8, operations may begin by setting a counter n equal to 1 that is used to track each of the reverse path signals that may be received from the cable modems at the N subscriber premises that are connected, for example, to a particular server at the CATV network headend facilities (block 600). At the same time, a timer may also be set to zero (block 600). Then, the signal-to-noise (“S/N”) ratio (or other performance parameter or parameters) is measured (e.g., at the headend facilities) for the reverse path signal that is being received from the first of the N subscriber premises that are connected to the server (to the extent that such a reverse path signal is presently being transmitted) (block 605). If the measured S/N ratio for the reverse path signal from the first subscriber premise is unacceptable, operations proceed to block 625. If, instead, the measured S/N ratio is acceptable (block 610), then the counter n is incremented to n+1 (block 615) and a determination is made as to whether the reverse path signals from all N subscriber premises that are connected to the server have been tested (block 620). If they have, then operations may end. If not, operations return to block 605 where the S/N ratio is measured for the reverse path signal that is being received from the next (i.e., n+1) of the N subscriber premises that are connected to the server (to the extent that such a reverse path signal is presently being transmitted).

At block 625 (which is reached if at block 610 it is determined that the S/N ratio is unacceptable), the headend facilities can use known information such as information regarding which of the N subscriber premises were transmitting reverse path communications during any particular time slot and information regarding which particular tap units feed these subscriber premises to determine the particular tap units that were transmitting reverse path communications during the time slot when the unacceptable S/N ratio was measured at block 610. A determination is then made as to whether one or more than one tap units were transmitting reverse path communications at this time (block 630). If, at block 630, it is determined that only a single tap unit was transmitting at the relevant time, then that tap unit is identified as the tap unit that is the likely source of the reverse path noise, and operations may proceed to block 660 where additional optional operations may be performed to try to identify the specific subscriber premise(s) that are connected through the identified tap unit that are the source or sources of the reverse path noise. If it is instead determined at block 630 that multiple tap units were transmitting during the time slot when the unacceptable S/N ratio was measured at block 610, then, after an additional period of time, the S/N ratio is re-measured for the same (n^{th}) reverse path signal to determine whether or not the S/N ratio is now acceptable (block 635). At block 640, a comparison is made between the tap units that were identified in the determination that was made at block 625 and any determination made at block 635 where the S/N ratio was found to be unacceptable. Any tap unit that was identified in each and every one of these determinations is then identified at block 645 as a tap unit that had its reverse path connected to the headend facilities each and every time that an unacceptable S/N ratio was measured. These tap units represent potential reverse path noise sources.

A determination is then made as to whether one or more than one tap units have been identified at block 645 as the potential reverse path noise source(s) (block 650). If multiple tap units have been identified, the timer may be checked to see if a predetermined amount of time has passed (block 655). This timer may be used because at some point it becomes inefficient to continue to try to reduce the number of tap units that are potential noise sources through the process of the operations of blocks 635 through 650 of FIG. 8 by seeing how the S/N ratio changes over time as different tap units transmit on the reverse path, and instead the operations set forth starting at block 660 may be used to more specifically locate the reverse path noise source.

If at block 650 it is determined that only a single tap unit remains identified as the potential noise source and/or if at block 655 it is determined that the timer has hit a threshold, operations then proceed to block 660 where a counter m is set to 1 that is used to cycle through the M tap ports provided on the identified tap units. Then, operations proceed to block 665 where tap port m on the identified addressable tap unit or units is turned off in the reverse path by, for example, commanding the addressable tap unit to switch the tap port at issue into a high pass mode) and the S/N ratio is re-measured for the same (n^{th}) reverse path signal to determine whether or not the S/N ratio is now acceptable. If it is determined that the re-measured S/N ratio is acceptable (block 670), then operations proceed to block 675 where the m^{th} tap port on the identified tap unit (or tap units) is identified as the reverse path noise source. If at block 670 it is determined that the S/N ratio is still unacceptable, then a determination is made as to whether all M tap ports on the one or more identified tap units have been tested by turning the tap ports off individually and re-measuring the S/N ratio as described with respect to blocks 665-670 (block 680). If they have, then operations may end without identifying a specific subscriber premise as the reverse path noise source. If all tap ports have not yet been tested, operations proceed to block 685 where the m^{th} tap port is turned back on and the counter is incremented to m=m+1. Then operations proceed back to block 665 where the testing can be repeated with the m+1^{th} tap port turned off.

By the procedure described above, reverse path noise sources may be quickly identified, and this identification may be done from the headend facilities. In many cases, this methodology may be able to identify a specific subscriber premise that is introducing unacceptable amounts of reverse path noise into the network, and may do so without having to turn on and off an excessive number of reverse path addressable tap ports. In some instances such as, for example, when two or more subscriber premises are causing the reverse path noise problem, the exemplary operations set forth in the method of FIG. 8 may not always specifically identify the subscriber premise(s) that are contributing excessive reverse path noise. However, in these situations, the data that is recorded by the above described method may be further analyzed to identify tap units and/or individual tap ports that are likely sources of the reverse path noise insertion. Once tap ports have been identified as likely sources of reverse path noise insertion, those tap ports may be turned off (if addressable tap units are provided) to see if the noise goes away to thereby confirm the noise source locations.

It will further be appreciated that the particular method illustrated in FIG. 8 is exemplary in nature, and that it could be modified in numerous ways without departing from the scope of the present invention. For example, in some embodiments, various of the operations may be done in a different order than the order depicted. Likewise, in some embodiments, the operations of steps 630 through 655 may be omitted. In still other embodiments such as, for example, networks that do not have addressable tap units, the operations of steps 660 through 680 may be omitted and/or performed manually by an on-site service technician. Numerous other modifications are possible. Thus, it will be appreciated that the present invention encompasses a broad range of methods of identifying reverse path noise sources in a CATV network in which the signal quality of a signal transmitted from a subscriber premise through the CATV network is measured and determined to exceed a threshold to and then a determination is made as to which ones of a plurality of tap units were configured to provide reverse path connections during the time period when the measured signal quality exceeded this threshold.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. For example, any number of RF output ports may be supported by the various amplifier embodiments discussed herein.

That which is claimed is:

1. A radio frequency (“RF”) tap unit, comprising:
an RF input port;
an RF output port that is coupled to the RF input port;
a plurality of RF tap ports that are coupled to the RF input port;
a burst mode detection circuit that is coupled between the RF input port and at least one of the plurality of RF tap ports.

2. The RF tap unit of claim 1, wherein the burst mode detection circuit includes a burst detector circuit and a switching device that is controlled by an output of the burst detector circuit.

3. The RF tap unit of claim 2, further comprising a first diplexer and a second diplexer, wherein the burst detector circuit is coupled between the first and second diplexers.

4. The RF tap unit of claim 3, wherein the switching device has an output that is coupled to a low frequency port of the second diplexer, and wherein the switching device transfers signals present at an input of the switching device to the output of the switching device when the switching device is in a first state, and isolates the signals present at the input of the switching device from the second diplexer when the switching device is in a second state.

5. The RF tap unit of claim 4, wherein the switching device is configured to couple the signals present at the input of the switching device to a first matched termination when the switching device is in the second state.

6. The RF tap unit of claim 5, wherein the switching device is further configured to couple the low frequency port of the second diplexer to a second matched termination when the switching device is in the second state.

7. The RF tap unit of claim 4, wherein the burst detector circuit is configured to control the switching device to be in the first state when the burst detector circuit detects that a signal is being transmitted from at least one of the plurality of RF tap ports to the RF input port.

8. The RF tap unit of claim 3, wherein the switching device comprises a first switching device having an input port that is coupled to the first diplexer, a first output port and a second output port that is coupled to a first matched termination and a second switching device having a first output port that is coupled to the first output port of the first switching device, a second output port that is coupled to a second matched termination and an input port that is coupled to the second diplexer.

9. The RF tap unit of claim 3, further comprising a first directional coupler having an input that is coupled to a low frequency port of the first diplexer, a first output that is coupled to an input of the burst detector circuit, and a second output that is coupled to an input of the switching device.

10. The RF tap unit of claim 6, wherein the first matched termination comprises a first resistor that is terminated to a ground voltage and wherein the second matched termination comprises a second resistor that is terminated to the ground voltage.

11. The RF tap unit of claim 1, wherein the RF tap unit is an addressable tap unit that includes:
a radio frequency receiver that is configured to receive a radio frequency signal;
a filter circuit that is coupled between the RF input port and a first of the RF tap ports, the filter circuit including a plurality of signal paths and a first filter that is on a first of the plurality of signal paths; and
a plurality of switches that select one of the plurality of signal paths through the filter circuit, wherein the plurality of switches are controlled in response to data contained in the radio frequency signal.

12. The RF tap unit of claim 3, further comprising a power divider network, wherein the first and second diplexers are positioned between the RF input port and the power divider network.

13. The RF tap unit of claim 3, further comprising a power divider network, wherein the first and second diplexers are positioned between the power divider network and at least some of the plurality of RF tap ports.

14. A method of reducing reverse path noise funneling in a communications network, comprising:
determining that an intentional reverse path communication is being transmitted to a headend facility of the communications network through a radio frequency (“RF”) tap unit of the communications network; and
providing a reverse path connection through the tap unit in response to determining that the intentional reverse path communication is being transmitted.

15. The method of claim 14, wherein providing the reverse path connection through the tap unit in response to determining that the intentional reverse path communication is being transmitted comprises re-connecting a disconnected reverse path connection through the tap unit in response to determining that the intentional reverse path communication is being transmitted.

16. The method of claim 15, further comprising disconnecting the reverse path connection through the tap unit in response to determining that no intentional reverse path communication is being transmitted.

17. The method of claim 16, wherein a plurality of subscriber premises are connected to the headend facility through the RF tap unit, any one of which may transmit the intentional reverse path communication.

18. The method of claim 16, wherein the RF tap unit includes a burst mode detection circuit that is configured to detect if the intentional reverse path communication is being transmitted to the headend facility through the RF tap unit.

19. The method of claim 18, wherein the burst mode detection circuit includes a burst detector circuit that is configured to determine if the intentional reverse path communication is being transmitted through the RF tap unit, and a switching device that is controlled by an output of the burst detector circuit to disconnect the reverse path connection through the tap unit in response to determining that no intentional reverse path communication is being transmitted through the RF tap unit.

20. The method of claim 18, wherein the burst detector circuit controls the switching device to complete the reverse path connection through the RF tap unit in response to determining that the intentional reverse path communication is being transmitted through the RF tap unit, and the burst detector circuit further controls the switching device to couple the reverse path connection through the RF tap unit to a matched termination in response to determining that no intentional reverse path communication is being transmitted through the RF tap unit.

21. A method of identifying reverse path noise sources in a cable television (“CATV”) network, the method comprising:
measuring the signal quality of a signal transmitted from a subscriber premise through the CATV network; and
determining which ones of a plurality of tap units were configured to provide reverse path connections during a time period when the measured signal quality of the signal transmitted from the subscriber premise through the CATV network exceeded a threshold.

22. The method of claim 21, further comprising:
repeatedly measuring the signal quality of the signal transmitted from the subscriber premise through the CATV network and then determining which ones of a plurality of tap units were configured to provide reverse path connections during the respective time periods when the measured signal quality of the signal transmitted from the subscriber premise through the CATV network exceeded the threshold; and
identifying as the reverse path noise sources the ones of the plurality of tap units that were configured to provide reverse path connections during all of the respective time periods when the measured signal quality of the signal transmitted from the subscriber premise through the CATV network exceeded the threshold.

23. The method of claim 21, further comprising:
sending a control signal to an addressable tap unit that is connected to the CATV network, the control signal including a command for the addressable tap unit to reduce the upstream bandwidth between the CATV network and a first port on the addressable tap unit; and then
measuring the signal quality of another signal transmitted from the subscriber premise through the CATV network.

24. A burst mode detection circuit for a communications network, comprising:
a radio frequency (“RF”) input port;
an RF output port that is coupled to the RF input port;
a burst detector circuit that is coupled between the RF input port and the RF tap port; and
a switching device that is controlled by an output of the burst detector circuit.

25. The burst mode detection circuit of claim 24, further comprising:
a first diplexer that is coupled between the burst detector circuit and the RF output port; and
a second diplexer that is coupled between the RF input port and the burst detector circuit.

26. The burst mode detection circuit of claim 25, wherein the switching device transfers signals present at an input of the switching device to the second diplexer when the switching device is in a first state, and isolates the signals present at the input of the switching device from the second diplexer when the switching device is in a second state.

27. The burst mode detection circuit of claim 26, wherein the switching device is configured to couple the signals present at the input of the switching device to a first matched termination when the switching device is in the second state and is further configured to couple a low frequency port of the second diplexer to a second matched termination when the switching device is in the second state.

28. The burst mode detection circuit of claim 26, wherein the burst detector circuit is configured to control the switching device to be in the first state when the burst detector circuit detects that a signal is being intentionally transmitted from the RF output port to the RF input port.

29. The burst mode detection circuit of claim 25, further comprising a first directional coupler having an input that is coupled to a low frequency port of the first diplexer, a first output that is coupled to an input of the burst detector circuit, and a second output that is coupled to an input of the switching device.
